(19) United States
(12) Patent Application Publication
(10) Pub. No.: US 2025/0154066 A1
(43) Pub. Date: May 15, 2025

(54) CERAMIC FOAM AND METHOD FOR MANUFACTURING SAID CERAMIC FOAM FROM MINING TAILINGS

(71) Applicant: UNIVERSIDAD DE TALCA, Talca (CL)

(72) Inventor: Lina Marcela URIBE VÉLEZ, Talca (CL)

(21) Appl. No.: 18/838,800

(22) PCT Filed: Feb. 15, 2022
(86) PCT No.: PCT/CL2022/095001

§ 371 Date: Aug. 15, 2024

(51) Int. Cl. C04B 35/14; C04B 35/622; C04B 35/63; C04B 35/64; C04B 38/00; C04B 38/10

(52) U.S. Cl. CPC C04B 35/14; C04B 35/62204; C04B 35/6303; C04B 35/64; C04B 38/0051; C04B 38/0067; C04B 38/10; C04B 2235/3217; C04B 2235/3272; C04B 2235/3418; C04B 2235/6562; C04B 2235/6565; C04B 2235/6567; C04B 2235/77; C04B 2235/9607

(57) ABSTRACT

The present invention relates to a method for manufacturing a ceramic foam and the ceramic foam thus obtained, using raw material obtained from mining tailings, a fluxing agent, and glycerol as the sole foaming agent.

### TECHNICAL FIELD

The present invention relates to the technical field of ceramic or glass foams, particularly, it refers to a new ceramic foam and a method for manufacturing said ceramic foam using mining tailings as raw material and glycerol as the sole foaming agent.

### BACKGROUND

The mining industry worldwide generates around 5 to 7 billion tons of waste per year, which represents a serious environmental problem. These wastes or tailings not only occupy large extensions of land, but also contain heavy metals and other toxic elements that contaminate the environment. For this reason, several efforts have been made to reuse or transform these tailings into high value added by-products.

Recently, the use of these tailings has been proposed for the production of ceramic foams, also called glass foams. These foams have a wide variety of applications due to their unique physical and mechanical properties. They are particularly useful in the construction industry because it is a lightweight, resistant, chemically inert material, capable of controlling moisture, it has freeze tolerance, it is non-toxic and non-flammable, and it is an excellent thermal and acoustic insulator. Despite all the advantages it offers, ceramic foams have high manufacturing costs related to the crushing, milling, and production processes, which is a limiting factor for their mass use.

Different methods for obtaining ceramic foams from mining tailings have been described in the state of the art. For example, patent document CN112876214A discloses a microcrystalline ceramic foam comprising a mixture of ceramic foam raw material and glass frit. It uses as raw material tailings generated from the extraction of gold ores and other components such as bentonite, kaolinite, talc, and calcite to obtain a ceramic foam with a mechanical strength and apparent density that conforms to industry requirements. The method to obtain this microcrystalline ceramic foam requires, first, obtaining the glass frit by weighing, grinding, and mixing each of the previously mentioned components. Then, melting the mixture at a temperature between 1400-1550° C., maintaining the temperature between 1-3 hours, and cooling it to obtain the glass frit. Subsequently, the raw ceramic foam material and the glass frit are mixed to undergo two consecutive sintering processes, an annealing stage, and a cooling stage to obtain the microcrystalline ceramic foam.

Patent documents CN107522405A and CN107857477A disclose a method for obtaining ceramic foams from tailings generated from the extraction of silver or gold ores, respectively. Both methods include first combining silver or gold tailings to obtain glass frits with a certain chemical composition, melting the glass frits at a temperature between 1400-1500° C. for 5 to 8 hours, and then cooling them to obtain a raw glass foam material. Subsequently, the raw glass foam material is mixed with calcium carbonate or carbon black as a foaming agent, and ground for 6 to 8 hours. After all this initial processing, the sintering, annealing, and cooling processes are started to obtain the final foam glass.

Patent document CN103936454A discloses a ceramic foam using as raw material tailings generated from the extraction of gold and copper ores, comprising 75-90% of tailings, 5-10% of float glass powder, 3-8% of foaming agent, and 2-8% of additives. The foaming agent is a mixture of silicon carbide, calcium carbonate, and activated carbon. The additive is a mixture of borax and sodium carbonate. The method for obtaining this ceramic foam comprises mixing all components uniformly, compressing the mixture in a mold and calcining it at a temperature from 30° C. to 600° C. at a rate of 4-6° C./min, maintaining a temperature of 600° C. for 15 min, then at a rate of 6-9° C./min at a sintering temperature of 1000-1100° C. for 20-50 min. Then, it is cooled at room temperature to obtain the final ceramic foam.

Although there are methods for the use of mining tailings as raw material to obtain ceramic foams, all of them use additional components and additives that raise the price of the process and, consequently, of the product obtained with these methods. In addition, these methods consume a large amount of energy as they include stages that require high temperatures (above 1000° C.).

Consequently, new methods are required for obtaining ceramic foams using mining tailings as raw material, that are economical, and that allow obtaining high quality ceramic foams.

### SUMMARY OF THE INVENTION

The present invention relates to a new ceramic foam and a method for manufacturing said foam which is much more economical than those described in the prior art for manufacturing said ceramic foam using mining tailings as raw material and, surprisingly, glycerol as the sole foaming agent.

A first object of the present invention is a method for manufacturing ceramic foams comprising the stages of:
providing a raw material coming from mining tailings, wherein said raw material includes SiO₂ in a proportion of at least or about 70% m/m, and Fe₂O₃ in a proportion of less than or about 10% m/m;
mixing said raw material with a fluxing agent and glycerol as the sole foaming agent until a homogeneous mixture is obtained;
sintering the homogeneous mixture obtained; and
cooling the homogeneous mixture to obtain the ceramic foam.

Additionally, the method may include a stage in which the mining tailings are classified by size and those having a particle size less than or equal to 100 μm are selected.

In a preferred embodiment, the raw material includes Al₂O₃ in a proportion of at least or about 2% m/m, and the presence of at least one alkali and/or alkaline earth metal oxide which is selected from the group consisting of CaO, Na₂O, K₂O, MgO, and a mixture thereof.

In one embodiment of the method of the present invention, the fluxing agent is selected from the group consisting of sodium carbonate, sodium borate, lime, and/or a mixture thereof. Preferably, the fluxing agent is a mixture of sodium carbonate and lime.

In a preferred embodiment of the method, the raw material is added to the mixture in a proportion between 65-80% m/m, and the glycerol is added to the mixture in a proportion between 4-10% m/m. When the fluxing agent is a mixture of sodium carbonate and lime, these are added to the mixture in a proportion between 14-18% m/m of sodium carbonate, and between 4-6% m/m of lime.

The stage of the method of sintering the homogeneous mixture is preferably carried out at a temperature between 850-900° C. In a preferred embodiment of this stage of the method, said temperature is maintained for a time between 20-45 minutes. For this purpose, it is preferable that the temperature is gradually increased at a rate between 10-20° C. per minute.

The stage of the method of cooling the mixture comprises, preferably, a first stage in which the temperature of the homogeneous mixture is gradually decreased until a range between 500-550° C. is reached, and a second stage in which the homogeneous mixture is cooled until it reaches room temperature. In a preferred embodiment of the first cooling stage, the temperature is decreased at a rate between 5-6° C. per minute.

A second object of the present invention is a ceramic foam which is obtained by means of the method described herein. In this way, a ceramic foam is obtained having an apparent density of less than or about 1.5 ton/m³, preferably less than or about 0.8 ton/m³, a mechanical strength greater than or about 0.2 MPa, preferably greater than or about 0.4 MPa, and a mean pore size of less than or about 1.8 mm, preferably less than or about 1.0 mm. Additionally, the ceramic foam obtained has a thermal conductivity of less than or about 0.13 W/mK.

### BRIEF DESCRIPTION OF THE FIGURES

FIG. 1 shows a schematic of the process for manufacturing foam from gold and silver tailings. FIG. 1A shows a satellite photograph of a location from which tailings may be obtained. At this stage, after the tailings are obtained, they are classified by particle size (≤100 μm). FIG. 1B shows an example of the equipment used for manufacturing ceramic foams at laboratory level. At this stage, the process of mixing the tailings with the fluxing and foaming agents, pressing, and sintering of said mixture is carried out. FIG. 1C shows an example of the ceramic foam obtained. At this stage, the obtained ceramic foam is cooled and demolded.

FIG. 2 shows a graph with the effect of sintering temperature (850, 875, 900° C.) and foaming agent percentage (between 4-10% m/m) on the apparent density (ton/m³) of the ceramic foams manufactured with the raw material obtained from tailing P1, using 20 min of sintering.

FIG. 3 shows a graph with the effect of sintering temperature (850, 875, 900° C.) and foaming agent percentage (between 4-10% m/m) on the porosity percentage (%) of the ceramic foams manufactured with the raw material obtained from tailing P1, using 20 min of sintering.

FIG. 4 shows a graph with the effect of sintering temperature (850, 875, 900° C.) and foaming agent percentage (between 4-10% m/m) on the mechanical strength (MPa) of the ceramic foams manufactured with the raw material obtained from tailing P1, using 20 min of sintering.

FIG. 5 shows a graph with the effect of sintering temperature (850, 875, 900° C.) and foaming agent percentage (between 4-10% m/m) on the mean pore size (mm) of the ceramic foams manufactured with the raw material obtained from tailing P1, using 20 min of sintering.

FIG. 6 shows a graph with the effect of sintering time (20 to 45 min) and foaming agent percentage (6 and 8% m/m) on the apparent density (ton/m3) of the ceramic foams manufactured with the raw material obtained from tailing P1, using a sintering temperature of 875° C.

FIG. 7 shows a graph with the effect of sintering time (20 to 45 min) and foaming agent percentage (6 and 8% m/m) on the porosity percentage (%) of the ceramic foams manufactured with the raw material obtained from tailing P1, using a sintering temperature of 875° C.

FIG. 8 shows a graph with the effect of sintering time (20 to 45 min) and foaming agent percentage (6 and 8% m/mi) on the mechanical strength (MPa) of the ceramic foams manufactured with the raw material obtained from tailing P1, using a sintering temperature of 875° C.

FIG. 9 shows a graph showing the effect of sintering time (20 to 45 min) and foaming agent percentage (6 and 8% m/m) on the mean pore size (mm) of the ceramic foams manufactured with the raw material obtained from tailing P1, using a sintering temperature of 875° C.

FIG. 10 shows representative photographs of the ceramic foams manufactured with the raw material obtained from tailing P1, obtained at sintering times of 20 (FIG. 10A), 25 (FIG. 10B), and 30 (FIG. 10C) minutes at 875° C.

FIG. 11 shows a graph with the effect of sintering temperature (850, 875, 900° C.) and foaming agent percentage (between 4-10% m/m) on the apparent density (ton/m³) of the ceramic foams manufactured with the raw material obtained from tailing P2, using 20 min sintering.

FIG. 12 shows a graph with the effect of sintering temperature (850, 875, 900° C.) and foaming agent percentage (between 4-10% m/m) on the porosity percentage (%) of the ceramic foams manufactured with the raw material obtained from tailing P2, using 20 min of sintering.

FIG. 13 shows a graph with the effect of sintering temperature (850, 875, 900° C.) and foaming agent percentage (between 4-10% m/m) on the mechanical strength (MPa) of the ceramic foams manufactured with the raw material obtained from tailing P2, using 20 min of sintering.

FIG. 14 shows a graph with the effect of sintering temperature (850, 875, 900° C.) and foaming agent percentage (between 4-10% m/m) on the mean pore size (mm) of the ceramic foams manufactured with the raw material obtained from tailing P2, using 20 min of sintering.

FIG. 15 shows a graph with the effect of sintering time (20 to 45 min) and foaming agent percentage (6 and 8% m/m) on the apparent density (ton/m³) of the ceramic foams manufactured with the raw material obtained from tailing P2, using a sintering temperature of 875° C.

FIG. 16 shows a graph with the effect of sintering time (20 to 45 min) and foaming agent percentage (6 and 8% m/mi) on the porosity percentage (%) of the ceramic foams manufactured with the raw material obtained from tailing P2, using a sintering temperature of 875° C.

FIG. 17 shows a graph with the effect of sintering time (20 to 45 min) and foaming agent percentage (6 and 8% m/m) on the mechanical strength (MPa) of the ceramic foams manufactured with the raw material obtained from tailing P2, using a sintering temperature of 875° C.

FIG. 18 shows a graph showing the effect of sintering time (20 to 45 min) and foaming agent percentage (6 and 8% m/m) on the mean pore size (mm) of the ceramic foams manufactured with the raw material obtained from tailing P2, using a sintering temperature of 875° C.

FIG. 19 shows representative photographs of the ceramic foams manufactured with the raw material obtained from tailing P2, obtained at sintering times of 20 (FIG. 19A), 25 (FIG. 19B), and 30 (FIG. 19C) minutes at 875° C.

### DETAILED DESCRIPTION OF THE INVENTION

The present invention corresponds to a new ceramic foam and a new method for obtaining said ceramic foams whose main contribution is the use of tailings derived from mining to obtain a raw material and, surprisingly, glycerol as the only foaming agent.

There are several studies in the state of the art that show that the foaming agents used in the method are crucial to produce high quality ceramic foams, i.e., that are highly porous and that have homogeneous porous structures. Commonly used foaming agents include calcium carbonate, silicon carbide, carbon black, or mixtures of sodium metasilicate (Na₂SiO₃), also called soluble glass, and glycerol, among others. Regarding this mixture, the state of the art teaches that the sodium metasilicate:glycerol ratio is critical in the ceramic foam pore formation process. For example, Yatsenko, E., et al. reported that the use of glycerol in the absence of soluble glass as a foaming agent results in a highly dense structure with no observable pores (Yatsenko, E., Goltsman, B., Kosarev, A., Karandashova, N., Smolii, V., & Yatsenko, L. Synthesis of Foamed Glass Based on Slag and a Glycerol Pore-Forming Mixture. Glass Physics and Chemistry. 2018, 44:152-155).

However, contrary to what the prior art teaches, the inventors of the present invention succeeded in obtaining high quality ceramic foams using mining tailings as raw material and the addition of only glycerol as foaming agent, without the need to add sodium metasilicate or other foaming agent.

Additionally, the method of the present invention is simpler and more economical than those described in the prior art. For example, it uses sintering temperatures below 1000° C., so energy consumption is much lower. In addition, it does not require initial stages of grinding or the addition of glass or other components to supplement the raw material obtained from tailings.

All technical and scientific terms used to describe the present invention have the same meaning as understood by a person with basic knowledge in the technical field in question. However, in order to define the scope of the invention more clearly, a list of the terminology used in this description is included below.

The terms “about” or “approximately”, or the symbol “W”, used interchangeably throughout the present specification, should be understood as the value or range of a parameter including a standard deviation of error according to the method or apparatus used to determine said value or range, and which is within the acceptable tolerance or statistically significant range for the value of said parameter. Said statistically significant range may be, for example, within 30%, 20%, 10%, or 5% of the indicated value or range. That is, the values and ranges mentioned are not and need not be exact, and may be approximate, either equal, lower, or higher. The term “between” when referring to ranges should be understood as around the lower value and around the upper value mentioned.

The term “room temperature” should be understood as the range or value of temperature in the surrounding area where the method of the present invention is carried out. A person skilled in the art will understand that said temperature values vary depending on multiple factors such as the seasons of the year, devices or equipment in the surroundings that may be producing an increase or decrease in temperature, among others. Typically, room temperature is between approximately 20-25° C., however, it may be higher or lower than said range without affecting the method or the result obtained from said method.

The terms “glass foam” or “ceramic foam” refer to the same object and are used interchangeably throughout this specification.

The term “tailing” should be understood as the residue, set of wastes generated as a result of the extraction of minerals in plants for the concentration of mineral species.

A first object of the present invention corresponds to a method for obtaining ceramic foams. The first stage of this method comprises providing a raw material from tailings for the manufacturing of ceramic foams. For this purpose, tailings coming from mining, preferably from mining in which ores of metallic compounds are extracted, obtained, or collected. For example, mining tailings may come from the extraction of copper, gold, or silver ores, among others, without being limited to these. In one embodiment of the present invention, the mining tailings come from the extraction of gold and silver ores.

The tailings provided to carry out the present method may be obtained from different tailings deposits to favor the homogeneity thereof, however, this procedure is a non-essential suggestion to obtain the ceramic foams described herein according to the present method.

In general, it is recommended that the particle size of the tailings used to obtain the raw material used for manufacturing or producing ceramic foams be less than or equal to 100 μm. Therefore, it is advisable, but not essential for carrying out the method of the present invention, to classify these tailings by size and select those which only contain particles less than or equal to 100 μm. For example, conveniently, the particle size of the tailings obtained from the extraction of gold and silver ores is mostly less than or equal to 100 μm, so that an initial crushing and grinding stage is not required for this case. Since these tailings still comprise a small quantity of particles larger than 100 μm, it is suggested to perform said classification to obtain a more uniform product. Said classification may be performed, for example, with a sieve with a mesh size less than 140 (U.S. Mesh), or using a cyclone or hydrocyclone, but not limited to these.

In order to obtain the ceramic foams of the present invention, the raw material obtained from mining tailings should have at least about 70% m/m of silicon oxide (SiO₂) and an amount of less than or about 10% m/m of iron oxide (Fe₂O₃), preferably an amount of less than or about 7% m/m. There are mining tailings that have said proportion of oxides when collected, and others that may have a high proportion of Fe₂O₃ which would be detrimental to the physical characteristics of the ceramic foams. In the latter case, it would be necessary to carry out a previous stage to lower the percentage by weight of said compound. In one embodiment of the present invention, when the tailing has a percentage m/m of Fe₂O₃ significantly greater than 10, a flotation process is carried out, which allows obtaining a raw material with a proportion of SiO₂ and Fe₂O₃ within the required values. In a preferred embodiment, the flotation process is carried out when the tailing has a proportion of Fe₂O₃ associated to the pyrite mineral significantly higher than 5% m/m. However, any other process of the prior art may be performed for this purpose.

In a preferred embodiment of the invention, the raw material further comprises aluminum oxide (Al₂O₃), which favors the formation of the glass network in the foams. Preferably, the raw material comprises a proportion of Al₂O₃ greater than or about 2% m/m. In another preferred embodiment, the raw material comprises a proportion of Al₂O₃ between 2-17% m/m, approximately.

In another preferred embodiment of the invention, the raw material further includes the presence of alkali and/or alkaline earth metal oxides (groups 1 and 2 of the periodic table according to the IUPAC nomenclature, respectively). The presence of one or a combination of alkali and alkaline earth metal oxides helps decrease the sintering temperature and promotes the formation of the liquid phase during the formation of the ceramic foam. In a preferred embodiment of the invention, said alkali and/or alkaline earth metal oxides are selected from calcium oxide (CaO), sodium oxide (Na₂O), potassium oxide (K₂O), and magnesium oxide (MgO), either one or a combination of these.

The raw material may also include other oxides such as titanium oxide (TiO₂), manganese(IV) oxide (MnO₂), copper(II) oxide (CuO), zinc oxide (ZnO), lead(II) oxide (PbO), sulfur(VI) oxide (SO₃), or others. These other oxides are not of great relevance because they produce insignificant variations in the characteristics of the ceramic foams of the present invention.

After obtaining the raw material, it is mixed with a fluxing agent and a foaming agent. For the purposes of the present invention, the foaming agent used consists of glycerol, also called glycerin or, in its IUPAC designation, 1,2,3-triol propane (C₃HO₂). One of the advantages of the present invention is that no other foaming agent is required to obtain a high quality ceramic foam.

On the other hand, the addition of a fluxing agent to the mixture is useful since it allows to lower the sintering temperature required in the method of obtaining the ceramic foams. This is highly desirable to reduce the energy cost of this method. In a preferred embodiment, the fluxing agent may be sodium carbonate (Na₂CO₃), sodium borate, lime, and/or a mixture of any of these. Preferably, a mixture of sodium carbonate and lime is used. In a preferred embodiment, lime containing primarily CaO and which may have the presence of other oxides such as magnesium oxide is used. For example, commercial lime may be used whose composition is ≈85% m/m CaO, ≈1.0% m/m MgO, ≈10% m/m CaCO₃, ≈1.5% m/m Ca(OH)₂, other oxides less than ≈0.5% m/m.

When sodium carbonate and lime are used as fluxing agents, the raw material is mixed in a proportion between 65-80% m/m approximately, preferably between 68-76% m/m, sodium carbonate in a proportion between 14-18% m/m approximately, preferably about 16% m/m, lime in a proportion between 4-6% m/m approximately, preferably about 5% m/m, and glycerol as the sole foaming agent in a proportion between 4-10% m/m approximately. The percentages of proportion by weight of each fluxing or foaming agent used vary in dependence on the elemental composition of the raw material, therefore, the proportions of the fluxing and foaming agents fluctuate around those ranges, considering that the elemental composition of the raw material also varies around the ranges and values previously described. For this reason, it is recommended, but not mandatory, to analyze the elemental composition of the raw material before proceeding with the mixing stage.

In a preferred embodiment, the solid compounds, i.e., the raw material and the fluxing agent, are mixed first and then the liquid compounds, i.e., the glycerol, are added.

The operational parameters and conditions for obtaining ceramic foams of similar characteristics may also vary depending on the elemental composition of the raw material. For this reason, it is recommended, but not mandatory, to analyze the elemental composition of the raw material before proceeding with the following stages of the process. When using a raw material as described in the present invention, said parameters and conditions vary around the values and ranges described herein.

The mixing of all the ceramic foam compounds is carried out in a vessel, for example, in a cylindrical vessel or in any other shape, using an agitator, preferably mechanical, which may be, for example, a propeller agitator, paddle mixer, planetary mixer, or other, without being limited to these herein mentioned. When the tailings and the fluxing agents, preferably sodium carbonate and lime, are added, the mechanical agitator may operate at a constant speed of about 150 rpm for about 5 minutes and, subsequently, upon addition of the foaming agent glycerol the mixture is agitated until a homogeneous mixture is achieved. This is done in approximately at least 5 minutes at a speed of about 200 rpm. A person skilled in the art will understand that these parameters are not essential since they may vary depending on the devices or machinery used for these purposes.

After the stage of mixing the raw material, the fluxing agent, and the foaming agent, a stage is carried out to sinter the homogeneous mixture that was previously obtained. For this purpose, it is preferable that the homogeneous mixture is poured into high temperature resistant molds such as, for example, clay, ceramic, metallic molds, or any other type of material known in the state of the art for this purpose. Once the mixture is in the molds, it may be subjected to a compaction process which is carried out with a pressure of about 4 tons (≈0.039 MPa) when the process is carried out under laboratory conditions. This value may vary depending on the industrial conditions used. The compaction process is preferably performed with a hydraulic press, but could be performed with any other device or machinery known for this purpose.

Subsequently, the homogeneous mixture is taken to an oven, preferably a muffle, where said mixture is heated to a high temperature, less than 1000° C., preferably in the range between 850-900° C. approximately. In a preferred embodiment, the temperature is gradually increased, preferably at a rate between about 10-20° C. per minute approximately, preferably at a temperature of about 15° C. per minute, until the desired temperature range is reached, and maintained in said temperature range for about 20-45 minutes.

In the final stage of the method of the present invention, after the sintering process, a cooling stage of the homogeneous mixture is performed until the ceramic foam is obtained. In a preferred embodiment, the mixtures are cooled in the same furnace at a rate of between 5-6° C. per minute approximately, preferably at a rate of about 5.5° C. per minute, until a temperature of about 500-550° C. is reached, preferably about 500° C. The value or speed range used for the cooling stage usually depends on the type of furnace used. Subsequently, the cooling process is continued at room temperature, until the ceramic foam is completely cooled, i.e., it reaches a temperature equal or similar to room temperature.

A second object of the present invention corresponds to the ceramic foam obtained with the method described previously. Particularly, this ceramic foam has an apparent density (ρ_{App}) of less than or about 1.5 ton/m³, a mechanical strength (σ) greater than or about 0.2 MPa, and a mean pore size (Dp) of less than or about 1.8 mm. In a preferred embodiment of the invention, the ceramic foam with the best characteristics obtained has an apparent density (ρ_{App}) of less than or about 0.8 ton/m³, a mechanical strength (σ) greater than or about 0.4 MPa, a mean pore size (Dp) of less than or about 1.0 mm, a thermal conductivity (λ) of less than or about 0.13 W/mK.

By using the method of the present invention, the ceramic foam obtained may be offered on the market at a lower cost than current ceramic foams due to the energetic advantages provided by this manufacturing method and that the main raw material used corresponds to a waste obtained from the mining industry.

The following examples are intended to illustrate the invention and its preferred modalities, but under no circumstances should they be considered as a restriction to the scope of the invention, which will be defined by the wording of the claims attached hereto.

### EXAMPLES

### Example 1. Collection and Characterization of Mining Tailings

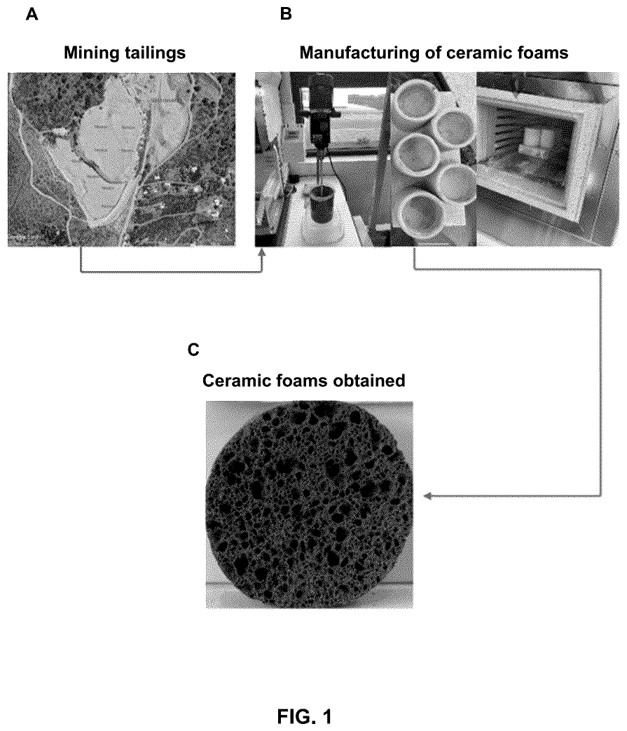

Tailings samples were collected from the Los Robles mining plant, located in the Chacón sector, in the O'Higgins Region, Chile (P1), and tailings samples from the Chépica Mine, located in the Maule Region, Chile (P2). The tailings were generated from flotation processes of gold and silver ores extracted from small-scale mining operations (FIG. 1A).

First, analyses were performed to determine the physical properties of the tailings. The samples underwent moisture analysis, which was determined by mass difference between the samples obtained and samples that were dried in an oven at 110° C. for 24 hours. They were also subjected to a density analysis, which was determined using a pycnometer, and a particle analysis performed using a particle size analyzer.

A particle size analysis of a representative sample of each of the tailings showed that the median particle size (X₅₀) for tailing P1 is about 38 μm and for tailing P2 is about 40 μm, and that 80% of the passing particle size (X₈₀) for both tailings P1 and P2 is about 78 μm. These values are in accordance with the recommended particle size in the state of the art for making ceramic foams, which should be less than or equal to 100 μm. The moisture for tailing P1 was about 13.3% and for tailing P2 was about 21%, and a density for tailing P1 of about 2.65 g/cm³ and for tailing P2 of about 2.70 g/cm³.

An analysis of the elemental and mineralogical composition of the tailings was also performed. The elemental composition was determined using a WD-XRF Bruker S8-TIGER spectrometer with a Rh excitation source. Briefly, 10 g of sample was used, which was crushed to a particle size of about 45 μm, and then placed in a 15 mm diameter, 1 mm deep aluminum container. Subsequently, the sample was pressed until it was compacted and then it was subjected to an analysis to determine its elemental composition using the spectrometer. The analysis of the mineralogical composition was determined by automated mineralogy, using TESCAN VEGA equipment equipped with TIMA Mineral Analyzer software. Bulk mineral analysis (BMA) mode was used in the equipment with a pixel size of 5 mm, current of 4.29 A, beam intensity 16.13, and a work distance of 15 mm, using an unground polished brick, which allowed describing the elemental contribution of silica.

The elemental composition of tailing P1 showed that silica (SiO₂) is the main component with 79.09% m/m of the total sample analyzed. In addition, 6.07% m/m of alumina (Al₂O₃), 6.49% m/m of iron oxide (Fe₂O₃), and 3.43% m/m of calcium oxide (CaO) were found in smaller proportions. The result is shown in Table 1. It is important to note that different minerals that make up the tailings include these compounds. Therefore, the values shown in Table 1 correspond to the total content of each compound, independent of the contribution of each mineral.

TABLE 1
Elemental composition of P1 tailing samples.

| Compounds | % m/m |
|---|---|
| SiO₂ | 79.09 |
| Al₂O₃ | 6.07 |
| Fe₂O₃ | 6.49 |
| CaO | 3.43 |
| Na₂O | 0.28 |
| K₂O | 1.40 |
| MgO | 1.31 |
| TiO₂ | 0.22 |
| MnO₂ | 0.35 |
| CuO | 0.16 |
| ZnO | 0.54 |
| PbO | 0.43 |
| SO₃ | 2.20 |

To determine which minerals are the ones that contribute to each of these compounds, a mineralogical analysis of the tailing P1 was carried out. The minerals found in greater proportion were: quartz (72.1% m/m), muscovite (5.7% m/m), chlorite (3.5% m/m), biotite (1.8% m/m), K-feldspar (2.1% m/m), garnet (2.5% m/m), and other minerals such as calcite (2.5% m/m), anhydrite (2.0% m/m), and pyrite (1.5% m/m), among others. The detail of the mineralogical composition is shown in Table 2.

TABLE 2
Mineralogical composition of P1 tailing samples.

| Mineral phase | Molecular Formula | % m/m |
|---|---|---|
| Quartz | SiO₂ | 72.13 |
| Muscovite | KAl₂(AlSi)₄O₁₀(OH, F)₂ | 5.66 |
| Chlorite | (Mg, Fe)₅Al(Si₃Al)O₁₀(OH)₈ | 3.48 |
| Garnet | (Ca, Fe, Mg,)₃(Al)₂(SiO₄)₃ | 2.54 |
| Calcite | CaCO₃ | 2.45 |
| Feldspar | KAlSi₃O₈ | 2.05 |
| Anhydrite | CaSO₄ | 2.01 |
| Biotite | K(Mg, Fe)₃AlSi₃O₁₀(OH, F)₂ | 1.82 |
| Pyrite | FeS₂ | 1.54 |
| Pyroxene | (Ca, Mg, Fe)(Al, Mg, Fe)(Si, Al)₂O₆ | 0.84 |
| Hematite | Fe₂O₃ | 0.79 |
| Tourmaline | AD₃Al₆(BO₃)₃(Si₆O₁₈)(OH, F)* | 0.68 |
| Epidote | Ca₂FeAl₂(Si₂O₇)(SiO₄)O(OH) | 0.65 |
| Amphibole | AB₂Y₅(Al, Si)₈O₂₂(OH, F, Cl)₂* | 0.60 |
| Oxides | (Cu, Fe)O | 0.53 |
| Albite | NaAlSi₃O₈ | 0.49 |
| Andesite | (Na, Ca)(Si, Al)₄O₈ | 0.40 |
| Sphalerite | (Zn, Fe)S | 0.36 |
| Siderite | FeCO₃ | 0.21 |
| Anorthite | CaAl₂Si₂O₈ | 0.20 |
| Galena | PbS | 0.06 |
| Others | — | 0.50 |
| Total | | 100.00 |

*A = Ca, Na, K, Pb; B = Ca, Fe, Mg, Mn, Li, Na; D = Al, Fe, Li, Mg, Mn, Ti; Y = Al, Cr, Fe, Mg, Mn, Ti

On the other hand, the elemental composition of tailing P2 also showed that silica (SiO₂) is the main component with 58.06% m/m of the total sample analyzed. In addition, 2.91% m/m of alumina (Al₂O₃) and 0.19% m/m of calcium oxide (CaO) were found in smaller proportions. However, the proportion of Fe₂O₃ was found to be too high (35.04% m/m) to produce ceramic foams directly using this tailing as raw material. The result of the analysis of the elemental composition of this tailing is shown in Table 3.

TABLE 3
Elemental composition of P2 tailing samples.

| Compunds | % m/m |
|---|---|
| SiO₂ | 58.06 |
| Al₂O₃ | 2.91 |
| Fe₂O₃ | 35.04 |
| CaO | 0.19 |
| K₂O | 1.35 |
| TiO₂ | 0.13 |
| MnO₂ | 0.06 |
| SO₃ | 37.57 |
| CuO | 0.21 |
| ZnO | 0.91 |
| PbO | 0.61 |

Regarding the mineralogical analysis of tailing P2, the minerals found in greater proportion were: quartz (55.06% m/m) and pyrite (34.57% m/m). Details of the mineralogical composition of tailings P2 are shown in Table 4.

TABLE 4
Mineralogical composition of P1 tailing samples.

| Mineral phase | Molecular Formula | % m/m |
|---|---|---|
| Quartz | SiO₂ | 55.06 |
| Pyrite | FeS₂ | 34.57 |
| Muscovite/illite | KAl₂(AlSi)₄O₁₀(OH, F)₂ | 2.60 |
| Chlorite | (Mg, Fe)₅Al(Si₃Al)O₁₀(OH)₈ | 2.39 |
| K-Feldspar | KAlSi₃O₈ | 2.77 |
| Biotite | K(Mg, Fe)₃AlSi₃O₁₀(OH, F)₂ | 0.53 |
| Sphalerite | (Zn, Fe)S | 0.76 |
| Hematite/Magnetite | Fe₂O₃ | 0.03 |
| Tourmaline | AD₃Al₆(BO₃)₃(Si₆O₁₈)(OH, F) * | 0.10 |
| Epidote | Ca₂FeAl₂(Si₂O₇)(SiO₄)O(OH) | 0.03 |
| Oxides (Fe, Cu) | (Cu, Fe)O | 0.10 |
| Amphibole | AB₂Y₅(Al, Si)₈O₂₂(OH, F, Cl)₂ * | 0.01 |
| Galena | PbS | 0.52 |
| Albite | NaAlSi₃O₈ | 0.01 |
| Andesite | (Na, Ca)(Si, Al)₄O₈ | 0.04 |
| Chalcopyrite | CuFeS₂ | 0.296 |
| Siderite | FeCO₃ | 0.01 |
| Anorthite | CaAl₂Si₂O₈ | 0.015 |
| Others | — | 0.17 |
| Total | | 100.00 |

* A = Ca, Na, K, Pb; B = Ca, Fe, Mg, Mn, Li, Na; D = Al, Fe, Li, Mg, Mn, Ti; Y = Al, Cr, Fe, Mg, Mn, Ti

Due to the high pyrite content, in order to use raw material from tailing P2, a flotation process was carried out consisting basically of three stages: 1) conditioning, 2) flotation, 3) filtration and drying (Salazar C., and Uribe L. An Alternative Method for the Obtention of Ceramic Foams from Gold and Silver Tailings with High Pyrite Content. Processes. 2021, 9(11):1897). The conditioning consisted of adding water, the tailing in suspension prepared with tap water (in this case tailing P2, 33% of solids), and the flotation reagents (collector, frother, and pH stabilizing agents (hydrochloric acid)) in a flotation cell, and then agitating this mixture for a period of 5 minutes. Once this was completed, the flotation stage was continued with the injection of air into the cell, which generates the separation of the materials of interest, due to the formation of bubbles that transport the hydrophobic minerals to the surface of the cell (mainly pyrite minerals and other sulfides of copper, zinc, and lead, in this case), generating at the end of this stage two products called concentrate (rich in silicates) and tail (rich in sulfides, mainly pyrite). This process was carried out for 15 minutes at pH 4, using an airflow of 5 L/min, at a stirring speed of 800 rpm, and automatic agitation every 10 seconds.

Finally, the filtration and drying process of the silicate-rich concentrate and the sulfide-rich tailing material was carried out using a pressure of 20 psi during filtration and a drying temperature of 200° C. for 24 hours.

Table 5 shows the quantity of each of the reagents used for each flotation. This table highlights the use of methyl isobutyl carbinol (MIBC) as a foaming agent to allow the flotation of sulfide minerals such as pyrite, potassium amyl xanthate (PAX) as a collector of sulfides such as pyrite, and lime and hydrochloric acid as pH stabilizing agents.

TABLE 5
Reagents used in the P2 tailing flotation process.

| Reagents | Quantity |
|---|---|
| MIBC | 20 g/ton |
| PAX | 60 g/ton |
| Hydrochloric acid | 1 ml of 0.6% solution |

Through this flotation process it was possible to increase the presence of SiO₂ by 22.15% m/m and reduce the presence of Fe₂O₃ by 90.90% and SO₃ by 90.95% m/m, mainly associated with the pyrite phase and to a lesser extent with copper, zinc, and lead sulfides. The results are presented in Table 6.

TABLE 6
Elemental composition of the P2 tailing
samples after the flotation process.

| Compounds | % m/m |
|---|---|
| SiO₂ | 70.92 |
| Al₂O₃ | 2.87 |
| Fe₂O₃ | 3.19 |
| CaO | 0.08 |
| K₂O | 1.23 |
| TiO₂ | 0.13 |
| MnO₂ | 0.09 |
| SO₃ | 3.40 |
| CuO | 0.03 |
| ZnO | 0.05 |
| PbO | 0.25 |

### Example 2. Manufacturing of Ceramic Foams

The tailings samples previously obtained were dried in an oven at 100° C. for approximately 24 hours and were classified by sieving, using a 140 mesh (U.S. Mesh), selecting the particles with a size less than or equal to 100 μm to obtain the raw material for the manufacturing of ceramic foams.

The raw material (74.9%; 72.9% m/m; 70.9% m/m; 68.9% m/m, depending on the percentage of glycerol added), 16% m/m sodium carbonate, and 5.1% m/m lime were mixed by mechanical agitation for 5 min at 92 g. Then, glycerol (4% m/m; 6% m/m; 8% m/m; 10% m/m) was added and agitated for 5 minutes at 100 g (FIG. 1B).

After obtaining a homogeneous mixture, the mixture was poured into 4.5 cm diameter clay molds and compaction was performed with 4 tons for 3 minutes (FIG. 1B).

Subsequently, the samples were taken to the muffle furnace to perform the sintering process by means of a heating ramp at a heating rate of about 15° C./min considering different glycerol percentages (between 4-10% m/m), temperatures (between 85° and 900° C.), and sintering times (between 20 and 45 minutes), depending on the experiment carried out (FIG. 1B). After this time, the samples were cooled at a rate of about 5.5° C./min until a temperature of about 500° C. was reached. It was possible to determine that the cooling rate was around 5.4 and 5.8° C./min, but these values depend on the furnace and equipment used to measure the temperature. Once this was completed, cooling was carried out at room temperature (FIG. 1C).

### Example 3. Characterization of the Ceramic Foams Obtained

The apparent density (ρApp [ton/m³]), porosity percentage, mean pore size (Dₚ [mm]), and mechanical strength (σ [MPa]) of the obtained ceramic foams were determined according to the methodology described by Uribe L, et al. (Uribe L, Moraga C, Rivas F. Using Gold-Silver Tailings on the Elaboration of Ceramic Foams. J. Sustain. Met. 2021, 7:364-367).

Under the conditions and parameters used in the method of Example 2, the following results were obtained in the characteristics of the ceramic foams.

Ceramic Foams Obtained with P1 Tailing Raw Material

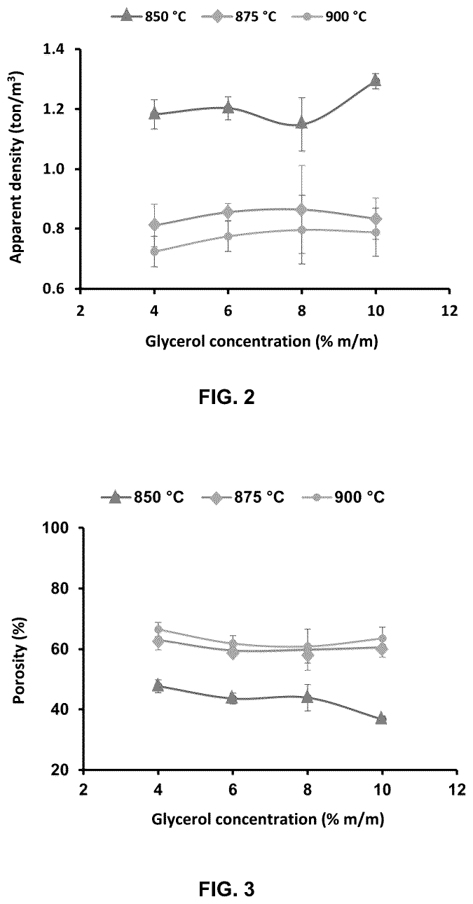

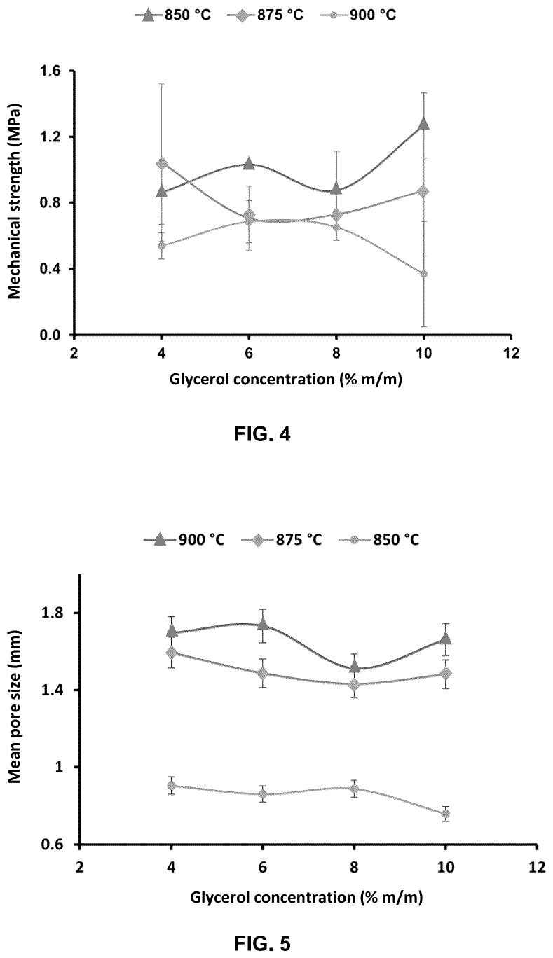

At a fixed sintering time of 20 min and evaluating the effect of temperature between 85° and 900° C. and the percentage of glycerol between 4 and 10% m/m, the results shown in FIGS. 2, 3, 4, and 5 were obtained. It can be observed that at temperatures 875° C. and 900° C., the apparent density remains below 1.0 ton/m³, independent of the glycerol proportion used (FIG. 2). At all temperatures and glycerol ratios tested, the porosity percentage of the ceramic foams is greater than 40% (FIG. 3). In turn, at all temperatures and glycerol ratios tested, the mechanical strength is greater than 0.4 MPa (FIG. 4), and the mean pore size is less than 1.8 mm (FIG. 5).

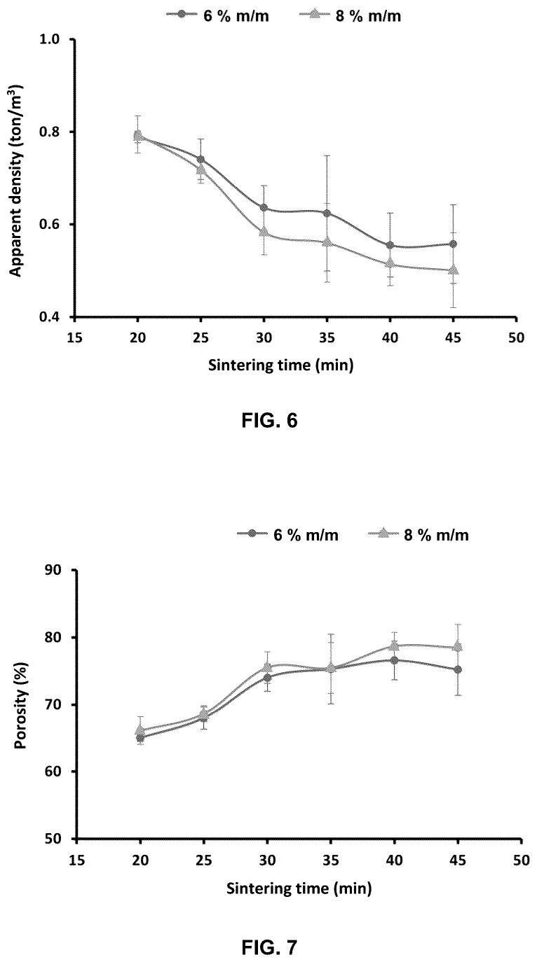

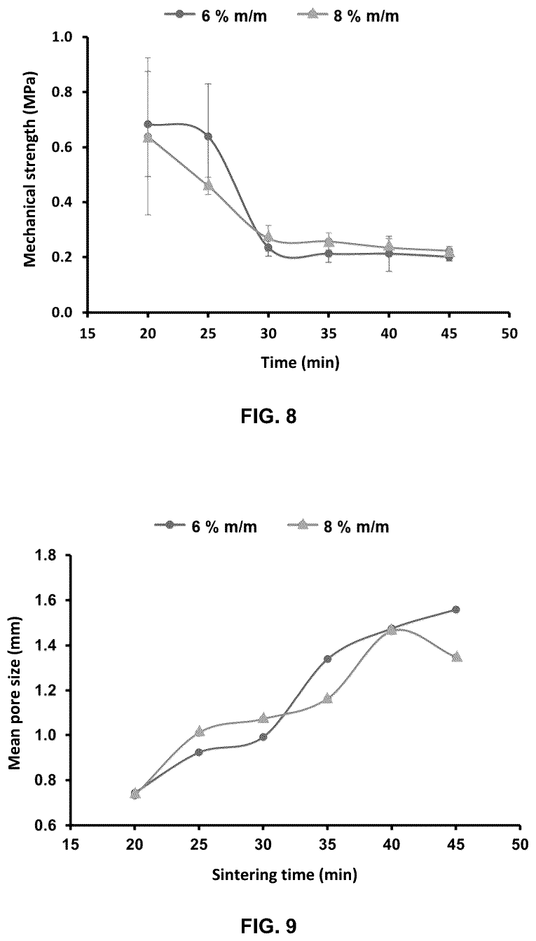

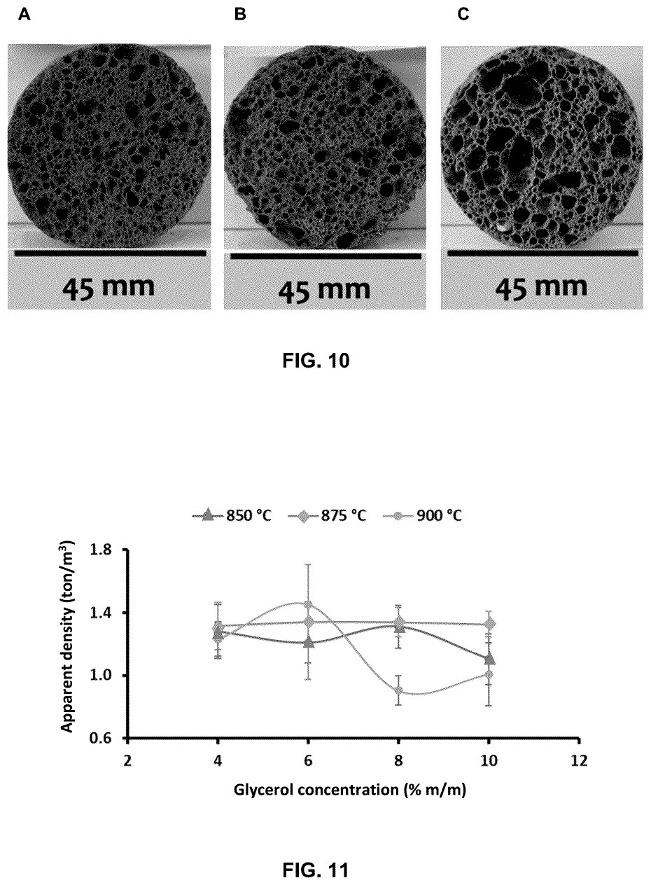

At a fixed sintering temperature of 875° C. and evaluating the effect of sintering time between 20 and 45 min and a foaming agent percentage of 6 and 8%, the results shown in FIGS. 6, 7, 8, and 9 were obtained. It can be observed that the apparent density remains below 0.8 ton/m³ (FIG. 6), the porosity percentage is higher than 60% (FIG. 7), and the mean pore size is less than 1.6 mm (FIG. 9), in all tested conditions. As for the mechanical strength, it is observed that between 20 and 25 minutes it remains above 0.4 MPa, regardless of the proportion of glycerol used (FIG. 8). FIG. 10 shows representative photographs of the ceramic foams obtained at sintering times of 20 (FIG. 10A), 25 (FIG. 10B), and 30 (FIG. 10C) minutes. It can be observed that, for sintering times of 20 and 25 minutes, the pore sizes are smaller than 5 mm.

From the above, it can be observed that the foams that developed the best characteristics were when using a temperature of 875° C., a time between 20 and 25 min, and a glycerol percentage between 6 and 8% m/m. Maintaining these conditions, the following characteristics were obtained in the foams:
Apparent density: less than 0.80 ton/m³
Porosity percentage: less than 70%
Mechanical strength: between 0.4 and 0.7 MPa
Mean pore size: less than 1.0 mm
Pore size: less than 5.0 mm
   Ceramic Foams Obtained with P2 Tailing Raw Material Post-Flotation

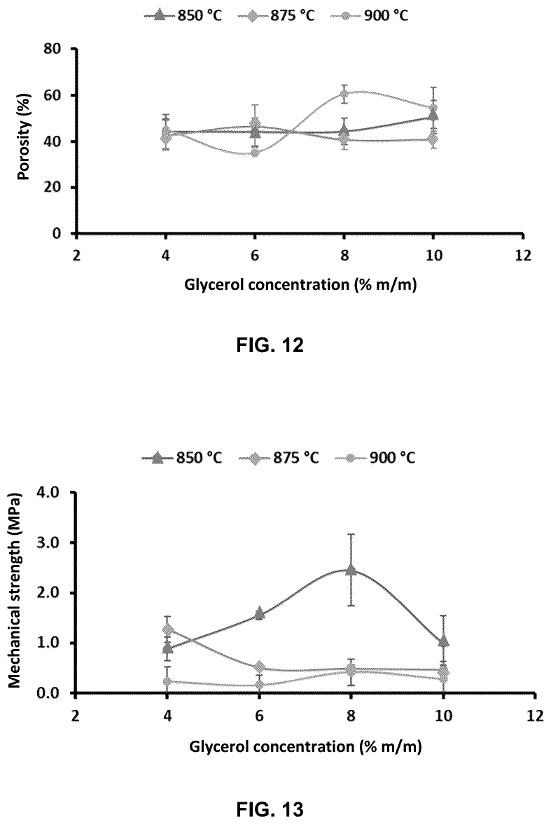

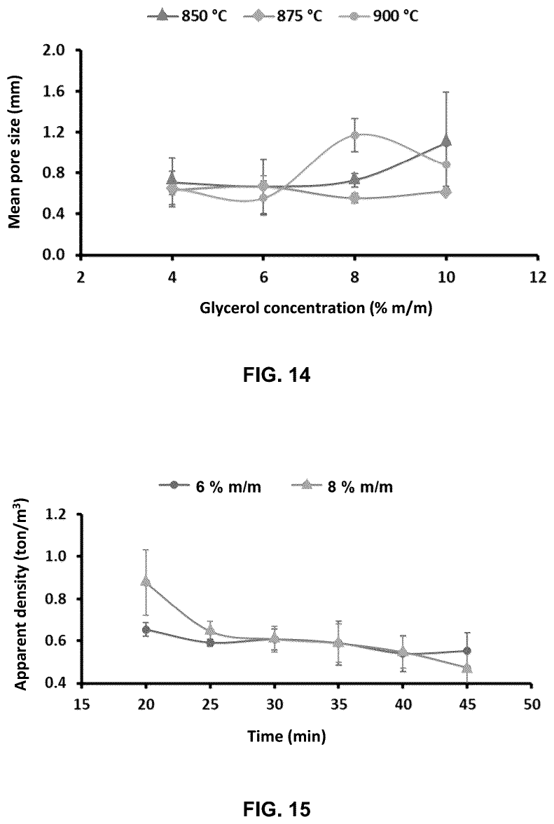

At a fixed sintering time of 20 min and evaluating the effect of temperature between 85° and 900° C. and the percentage of glycerol between 4 and 10% m/m, the results shown in FIGS. 11, 12, 13, and 14 were obtained. It can be seen that, at the temperature of 900° C., the apparent density remains below 1.0 ton/m³ if a glycerol ratio between 8 and 10% m/m is used (FIG. 11). At all temperatures and glycerol ratios tested, the porosity percentage of the ceramic foams is greater than 35% (FIG. 12). In turn, at temperatures of 850° C. and 875° C. and at all glycerol ratios tested, the mechanical strength is greater than 0.4 MPa (FIG. 13). At all temperatures and glycerol ratios tested, the mean pore size is less than 1.6 mm (FIG. 14).

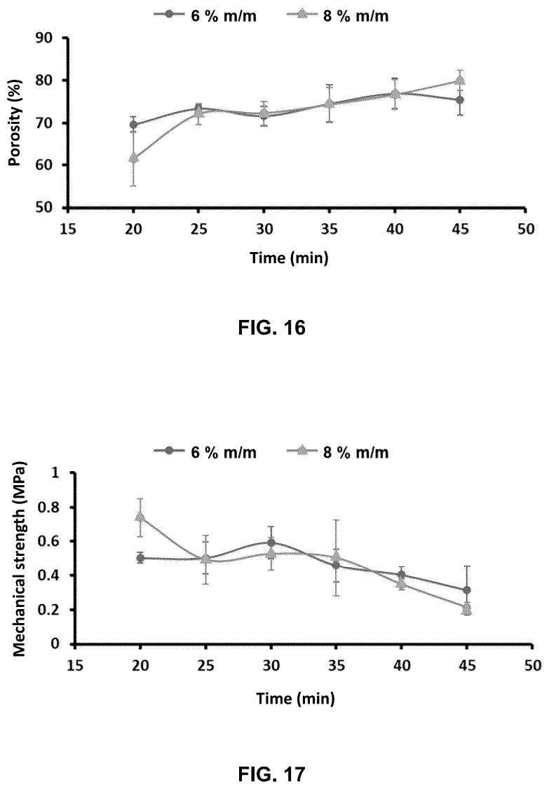

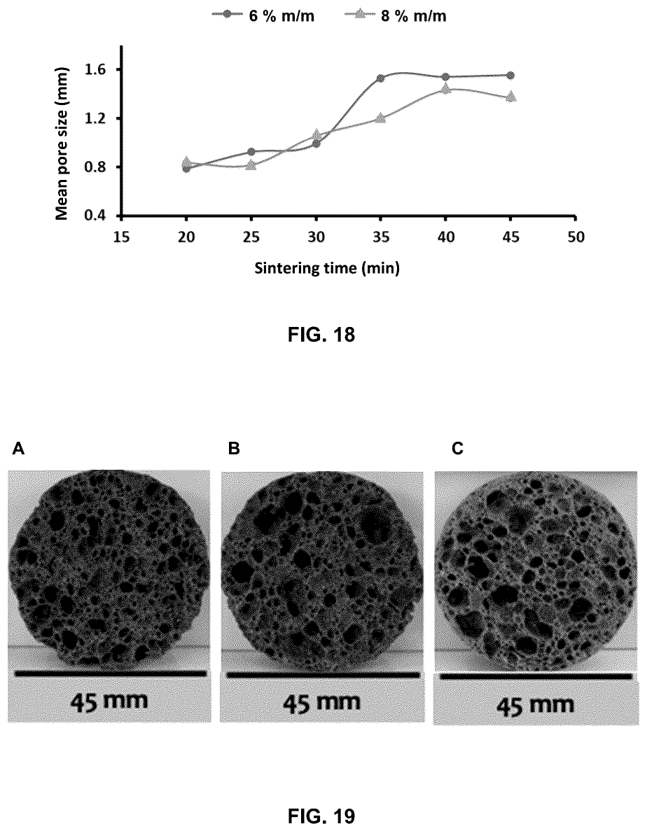

At a fixed sintering temperature of 875° C. and evaluating the effect of sintering time between 20 and 45 min and a foaming agent percentage of 6 and 8%, the results shown in FIGS. 15, 16, 17, and 18 were obtained. It can be observed that the apparent density remains below 0.9 ton/m³ (FIG. 15), the porosity percentage is higher than 60% (FIG. 16), and the mean pore size is less than 1.6 mm (FIG. 18), in all the tested conditions. As for the mechanical strength, it is observed that between 20 and 35 minutes it remains above 0.4 MPa, regardless of the proportion of glycerol used (FIG. 17). FIG. 19 shows representative photographs of the ceramic foams obtained at sintering times of 20 (FIG. 19A), 25 (FIG. 19B), and 30 (FIG. 19C) minutes at 875° C. Table 7 shows the characteristics of apparent density, porosity percent, mean pore size, and mechanical strength for each of these representative foams.

TABLE 7
Characteristics of the ceramic foams shown in FIG. 19.

| | ρ_{App} | Porosity | Mean pore | Mechanical |
|---|---|---|---|---|
| FIG. | (t/m³) | (%) | size (mm) | strength (MPa) |
| 19A | 0.65 | 69.57 | 0.79 | 0.50 |
| 19B | 0.59 | 73.41 | 0.92 | 0.50 |
| 19C | 0.61 | 71.66 | 0.99 | 0.59 |

In addition, the fire resistance of the foams produced was determined by means of thermal conductivity, vertical combustion, horizontal combustion and limiting oxygen index (LOI) tests. These tests were carried out at the Institute of Technological Research (IIT) of the University of Concepción.

For these tests, 30 cylindrical samples were analyzed, keeping the composition of ceramic foams fixed and varying the type of raw material according to the tailings from which they came (P1 and P2), having average dimensions of 6.5 cm in diameter and 2.5 cm thick. 6% m/m glycerol was used, and sintering temperature and time of 875° C. and 20 min, respectively, were used.

The thermal conductivity test was performed by measuring steady-state heat flux using a guarded-hot-plate apparatus (ASTM C177). The pre-test samples were conditioned at 22° C. and a relative humidity of 50% according to the standard for these analyses. The test time was 4 hours to achieve the stabilization of the hot plate and cold plate temperature. Table 8 shows the values obtained for 5 samples and their respective averages. The small differences observed in the thermal conductivity are mainly due to the method and type of material evaluated (material porosity), so these values are statistically similar.

TABLE 8
Values obtained from thermal conductivity tests (λ).

| Parameter | P1 (n = 5) | P2 (n = 5) |
|---|---|---|
| λ (W/mK) | 0.121 | 0.117 |
| Standard deviation (W/mK) | 0.005 | 0.005 |

On the other hand, the vertical combustion of ceramic foams was evaluated, for which samples of identical composition and geometry were subjected to a standard test flame for two 10-second flame applications. The post-flame time is recorded after the first flame application (t post-flame 1st exposure), and the post-flame and post-incandescence times are recorded after the second flame application (t post-flame 2nd exposure and t post-incandescence, respectively). Information on whether or not flaming material drips from the sample was also recorded. Table 9 shows the results of this test.

TABLE 9
Results obtained from the combustion test in vertical position.

| Parameter | P1 (n = 3) | P2 (n = 3) |
|---|---|---|
| Thickness (mm) | 24.23-26.34 | 21.71-24.11 |
| t post-flame | 0 | 0 |
| 1st exposure (s) | | |
| t post-flame | 0 | 0 |
| 2nd exposure (s) | | |
| t post-incandescence (s) | 0 | 0 |
| Dripping | No | No |

The horizontal combustion of these foams was also evaluated, for which the samples were supported on a grate and a flame was applied at one end for 60 seconds. With this, the combustion velocity (V combustion), the extent of combustion, and the post-incandescence and post-flame times were determined. Table 10 shows the results obtained.

TABLE 10
Results obtained from the horizontal
combustion test of samples P1 and P2.

| Parameter | P1 (n = 3) | P2 (n = 3) |
|---|---|---|
| Thickness (mm) | 24.26-28.40 | 23.66-29.18 |
| t post-flame | 0 | 0 |
| 1st exposure (s) | | |
| t post-flame | 0 | 0 |
| 2nd exposure (s) | | |
| t post-incandescence (s) | 0 | 0 |
| Dripping | No | No |

A test was also performed to determine whether the ceramic foams were flammable or not. For this purpose, the limiting oxygen index (LOI) test was performed. The samples were subjected to the action of a direct flame under standard conditions of oxygen and nitrogen (21% and 78%, respectively) and relative humidity of 50%. The results of these tests are shown in Table 11.

TABLE 11
Oxygen index results for ceramic foams.

| Parameter | P1 (n = 3) | P2 (n = 3) |
|---|---|---|
| Combustion at 21% O₂ | No | No |
| Flammable | No | No |

Considering the results obtained, the method of the present invention allows to provide a product with insulating properties, very low thermal conductivity, and with a higher efficiency compared to the same thickness of other products available in the market. Table 12 shows a comparison of the characteristics of the ceramic foam with the best characteristics obtained and two products currently available on the market.

TABLE 12
Comparison of properties between one of the ceramic foams of the
present invention and the ceramic foams available on the market.

| | Gold-Silver | Foamglas ® | Plaster- |
|---|---|---|---|
| Variable | Tailing | walls | Cardboard |
| ρ_{App} (ton/m³): | ≤0.8 | 0.4 | 0.6-1 |
| Dₚ (mm): | ≤1 | ≤4 | — |
| σ (MPa): | 0.4-0.7 | 0.5 | 5.0 |
| λ (W/mK): | 0.119 | 0.135 | 0.26 |

These excellent properties make the ceramic foam applicable in all civil works as thermal and acoustic insulation, and it can also be used to protect structural components against fire, humidity, and erosion.

1. A method for making ceramic foams, CHARACTERIZED in that it comprises the stages of:
providing a raw material coming from mining tailings, wherein said raw material includes SiO₂ in a proportion of at least or about 70% m/m, and Fe₂O₃ in a proportion of less than or about 10% m/m;
mixing said raw material with a fluxing agent and glycerol as the sole foaming agent until a homogeneous mixture is obtained;
sintering the homogeneous mixture obtained; and
cooling the homogeneous mixture to obtain the ceramic foam.

2. The method according to claim 1, CHARACTERIZED in that the raw material includes Al₂O₃ in a proportion of at least or about 2% m/m, and the presence of at least one alkali and/or alkaline earth metal oxide which is selected from the group consisting of CaO, Na₂O, K₂O, MgO, and a mixture thereof.

3. The method according to claim 1, CHARACTERIZED in that it additionally comprises a stage wherein the tailings are classified by size and those having a particle size less than or equal to 100 μm are selected.

4. The method according to claim 1, CHARACTERIZED in that the raw material is added to the mixture in a proportion between 65-80% m/m.

5. The method according to claim 1, CHARACTERIZED in that the glycerol is added to the mixture in a proportion between 4-10% m/m.

6. The method according to claim 1, CHARACTERIZED in that the fluxing agent is selected from the group consisting of sodium carbonate, sodium borate, lime, and a mixture thereof.

7. The method according to claim 6, CHARACTERIZED in that the fluxing agent is a mixture of sodium carbonate and lime.

8. The method according to claim 7, CHARACTERIZED in that the sodium carbonate is added to the mixture in a proportion between 14-18% m/m, and the lime is added to the mixture in a proportion between 4-6% m/m.

9. The method according to claim 1, CHARACTERIZED in that in the stage of sintering the homogeneous mixture a temperature between 850-900° C. is used.

10. The method according to claim 9, CHARACTERIZED in that the temperature is maintained for a time between 20-45 minutes.

11. The method according to claim 9, CHARACTERIZED in that in the stage of sintering the homogeneous mixture the temperature is gradually increased at a rate between 10-20° C. per minute.

12. The method according to claim 1, CHARACTERIZED in that the stage of cooling the mixture comprises a first stage in which the temperature is gradually decreased to a range between 500-550° C., and a second stage in which the homogeneous mixture is cooled until it reaches room temperature.

13. The method according to claim 12, CHARACTERIZED in that in the first stage the temperature is decreased at a rate between 5-6° C. per minute.

14. A ceramic foam, CHARACTERIZED in that it is obtained by the method of any one of claims 1 to 13, and has an apparent density of less than or about 1.5 ton/m³, a mechanical strength greater than or about 0.2 MPa, and a mean pore size of less than or about 1.8 mm.

15. The ceramic foam according to claim 14, CHARACTERIZED in that the apparent density is less than or about 0.8 ton/m³, the mechanical strength is greater than or about 0.4 MPa, and the mean pore size is less than or about 1.0 mm.

16. The ceramic foam according to claim 15, CHARACTERIZED in that it has a thermal conductivity of less than or about 0.13 W/mK.
